(19) United States
(12) Patent Application Publication
(10) Pub. No.: US 2014/0091136 A1
(43) Pub. Date: Apr. 3, 2014

(54) TRACKING SYSTEM FOR FOOD PRODUCTS

(71) Applicant: Jonas Ybarra, JR., Lott, TX (US)

(72) Inventor: Jonas Ybarra, JR., Lott, TX (US)

(21) Appl. No.: 13/688,579

(22) Filed: Nov. 29, 2012

Related U.S. Application Data
(60) Provisional application No. 61/708,285, filed on Oct. 1, 2012.

(51) Int. Cl. G06F 17/30; G06K 19/06; G06K 19/00

(52) U.S. Cl. CPC G06F 17/30002; G06K 19/00; G06K 19/06028; G06K 19/06037
USPC 235/375; 235/487; 235/494

(57) ABSTRACT

A system and method for providing food product information to customers. The system may include a database storing food product information, an information tag, such as a 2 dimensional QR code, with a link associated with the location of the food product information on the database, and a reader configured to retrieve at least some of the food product information when activated by a customer. The system may also include an information gatherer for acquiring food product information and an interface for transmitting the link to a device for generating the information tag. The method may include producing the information tag with the link to the food product information. The method may also include accessing the database using a reader and retrieving food product information over a communications medium.

### CROSS-REFERENCE TO RELATED APPLICATIONS

This application claims the benefit of U.S. application Ser. No. 61/708,285 filed Oct. 1, 2012, which application is hereby incorporated by reference for all purposes in its entirety.

### STATEMENT REGARDING FEDERALLY SPONSORED RESEARCH OR DEVELOPMENT

N/A

### REFERENCE TO MICROFICHE APPENDIX

N/A

### BACKGROUND OF THE DISCLOSURE

1. Field of the Disclosure

This disclosure generally relates to the field of product information, and, in particular, generating information tags, such as QR (Quick Response) codes that link to cattle/ranch product information.

3. Description of the Art

Generally, products are packaged with written labels or written tags containing identification and/or specification information for the specific product. The information may range from generic (color, brand, etc.) or highly specific (serial number, lot number, etc.). In the area of food products, consumers may be interested in the preparation, processing, and handling that taking place in bringing food products from farm or ranch to market. Most food product labeling includes the minimal information required by law and, possibly, additional information in the form of advertising. Information supplied to consumers on tags is often limited by the area of the tag and the size of print on the tag. Further, the information contained fails to provide full traceability of the history and production of the food product to consumers at the point of sale. What is needed is a method and system that will provide traceability of food products to consumers or end users at the point of sale that is readily accessible to the consumer.

### BRIEF SUMMARY OF THE DISCLOSURE

In aspects, the present disclosure is related to a system and method generating information tags. Specifically, the present disclosure is related generating information tags, such as QR codes, including links to information about food products that may be accessed by consumer accessible devices configured to read the information tags and retrieve the food product information at the consumer point of sale.

One embodiment according to the present disclosure includes a system for providing food product information, the system comprising: a non-transitory computer-readable medium; a database stored on the non-transitory computer-readable medium; the food product information stored in the database; an information tag associated with the food product and configured to be read by a reader; and a link between the information tag and the food product information in the database.

Another embodiment according to the present disclosure includes a method for providing food product information, the method comprising: generating an information tag configured to be disposed on packaging of a food product, the information tag configured to be read by a reader and comprising a link pointing to a location in a database, wherein the database comprises the food product information at the location and is stored on a non-transitory computer-readable medium.

Another embodiment according to the present disclosure includes a non-transitory computer-readable medium product, the non-transitory computer-readable medium containing instructions thereon that, when executed by at least one processor, perform a method, the method comprising: generating an information tag configured to be disposed on packaging of a food product, the information tag configured to be read by a reader and comprising a link pointing to a location in a database, wherein the database comprises the food product information at the location and is stored on a non-transitory computer-readable medium.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a product information tag process according to one embodiment of the present disclosure;

FIG. 2 shows a product information tag process for producing the information tag with a link to the product information database according to one embodiment of the present disclosure;

FIG. 3 shows a product information tag process for accessing data in the database using the information tag according to one embodiment of the present disclosure;

FIG. 4 shows a flow chart of a method for providing product information to a user according to one embodiment of the present disclosure; and

FIG. 5 shows a system for providing product information to a consumer according to one embodiment of the present disclosure.

### DETAILED DESCRIPTION OF THE DISCLOSURE

Generally, the present disclosure involves a method and system for generating an information tag including a link to detailed information about a product associated with the information tag, specifically involving food products and detailed information about the growing, processing, and handling of the food products. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

Consumers are generally not provided with sufficient information to trace the food products that they are buying. Food product details such as point of origin, date of birth, and genetic data, etc. may be of interest to consumers that have specific interests or prerequisites regarding the food that they purchase. The embodiments described below make food product information beyond mere visual labeling available to consumers.

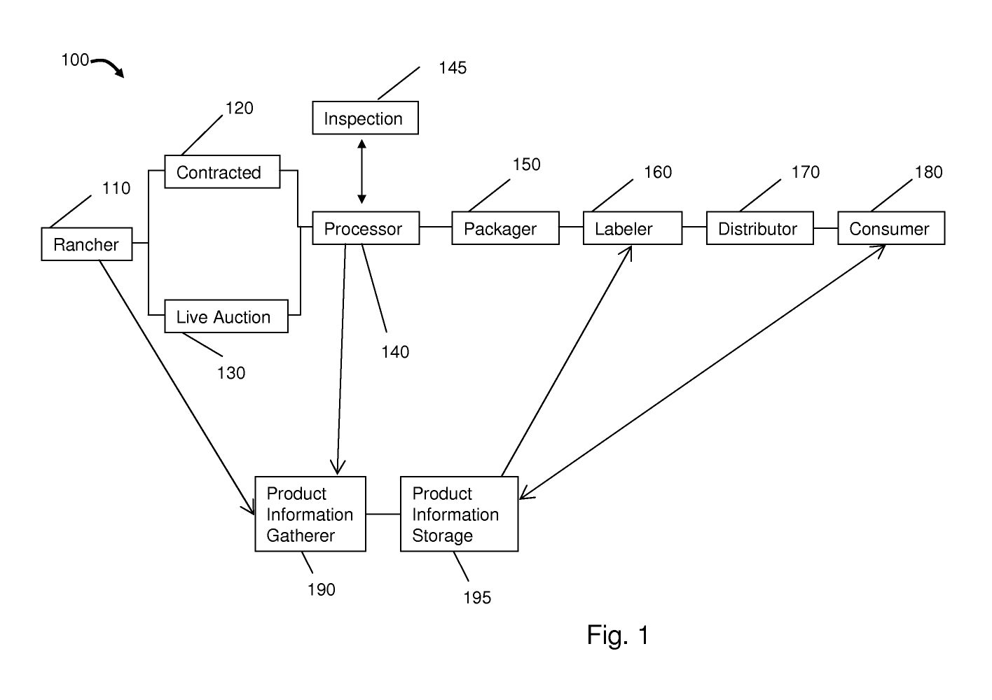

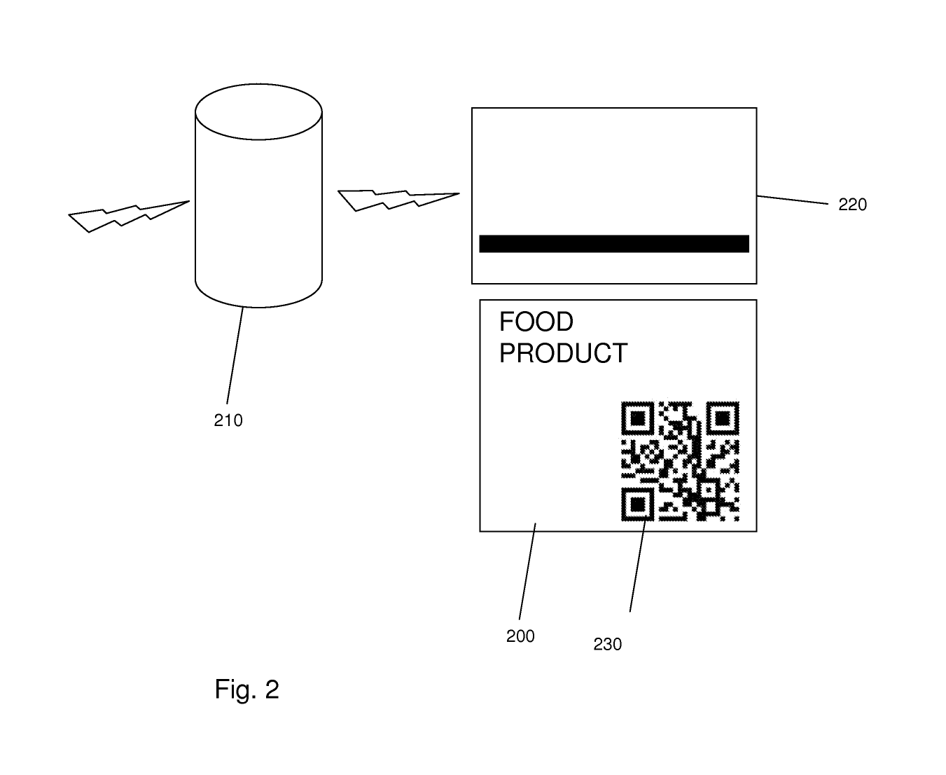

FIG. 1 shows a diagram of an exemplary food product information process according to one embodiment of the present disclosure. Herein, the term “food product” includes raw and processed consumables for humans and other living creatures. In one exemplary embodiment, the food product may be meat, however, one of ordinary skill in the art would understand that this is not a limitation, as substantially similar processes may be used with, but is not limited to, fresh produce, processed foods, and spices. A food producer, such as a rancher 110 may raise a meat source animal (cattle, pigs, chickens, etc.). In some embodiments, the food producer may be a farmer cultivating crops. The food producer may sell his food product to a processor 140 for preparation for delivery to the consumer 180. In this example, the rancher 110 may sell the meat source animal by a contract process 120 or via a live auction process 130. Processes 120 and 130 may be optional in some embodiments. The processor 140 may conduct steps for preparing the meat source animal for transformation into the food product, including, but not limited to, killing, slaughtering, dressing, time or duration in the freezer/cooler and freezer/cooler temperature. During the processing, the meat may be inspected and/or graded by a third party inspector 145, such as the United States Department of Agriculture (USDA). After processing, the processor 145 may pass the meat to a packager 150, which will package the meat. Once the packaging is on the meat, the packager 150 may send the packaged meat to a labeler 160. The labeler 160 may provide an information tag 200 (see FIG. 2) that includes a link and may be disposed on the packaged meat. Information tags may be disposed on the package in any method known to one of ordinary skill in the art, including, but not limited to, tying and adhesive. The information tag 200 may include general information about the meat, including but not limited to, government required disclosures, health and calorie information, ingredients, brand name, weight, and volume. The information tag 200 may include sufficient space for readable text and images. After the meat is labeled, the meat may be dispensed by a distributor 170, such as a grocer or wholesaler. Finally, the meat may be received or purchased by the consumer 180. Herein, the consumer 180 represents any party downstream of the labeler 160 and initial distributor that may have an interest tracing the food product. The term “consumer” may include but is not limited to an end user. In some cases, a single party may perform multiple roles, and these grouping of these roles may change based on the type of food product and business model. For example, a processing company may act as processor, packager, and labeler; while in another embodiment, a distribution company may act as packager, labeler, and distributor. In some cases, one or more roles may be divided across multiple parties.

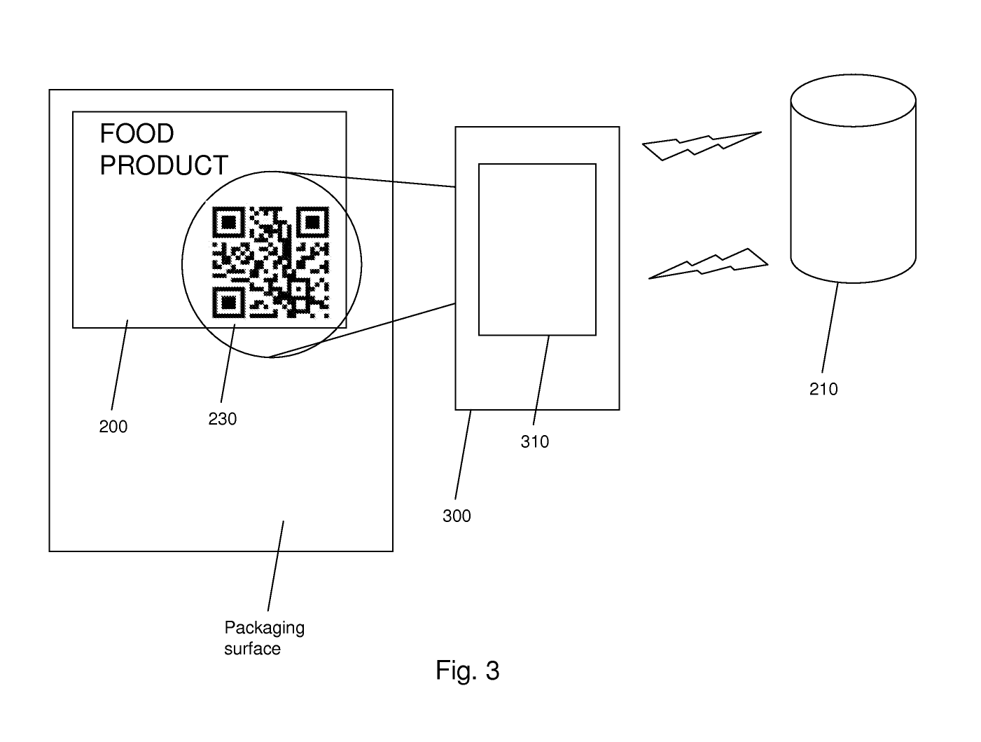

Throughout the above process, the information about the food product may have been gathered by a product information gatherer 190, which may include an interface configured to receive food product information, such as a computer interface or software program. The product information gatherer 190 may be interfaced with a product information storage medium 195 configured to store information about the food product. Since different aspects of the food product information may be gathered throughout the transformation from animal at the rancher 110 to a product in the hands of the consumer 180, the product information gatherer 190 may be configured to receive food product information from different sources. For example, the rancher 110 may transmit genetic data, date of birth, type of feed, hormone usage, antibiotic usage, contact information, and source location data to the product information gatherer 190. In embodiments where the food product is fresh produce, the food producer may additionally transmit fertilizer data, date of planting, organic/non-organic status, etc. A processor 140 may transmit date of processing, inspection results, and quality or grade ratings to the product information gatherer 190. The above lists of data types provided to the product information gatherer are illustrative and exemplary only, as any relevant type of data known to a person of ordinary skill in the art may be provided to the product information gatherer 190. When the product information is received by the product information gatherer 190, the product information may be stored in product information storage 195, which may be accessed by the labeler 160. The labeler 160 may generate an information tag 200 and dispose the information tag 200 on the packaging. The consumer 180 may read the information tag 200 using a suitable reader 300 (see FIG. 3) configured to follow the link in the information tag 200 and retrieve at least some food product information from product information storage 195.

FIG. 2 shows an exemplary process diagram for generating the information tag 200. The information tag 200 may include a link and be configured to be read by a suitable machine reader 300. The link may be embedded in a bar code 230. The bar code 230 may include on or more of: (i) a linear bar code and (ii) a two-dimensional bar code, such as a Quick Response (QR) code. In some embodiments, bar code 230 may substantially occupy the area of the information tag 200. In some embodiments, information tag 200 may have areas not occupied by bar code 230 that may be available for other images or text. Food product information may be transmitted to a database 210 located on product information storage medium 195. The location of the food product information on database 210 may then be transmitted to a label production device 220. The label production device 220 may be configured to convert the location on the database 210 into a link that may be embedded in bar code 230. In some embodiments, the function of the label production device 220 may be performed by multiple sub-devices. The label production device 220 may print an information tag 200 including bar code 230 on a suitable medium that may be disposed on the packaged food product.

FIG. 3 shows a process diagram of how a consumer 180 may retrieve the food product information after the information tag 200 has been disposed on the food product 320. The bar code 230 section of information tag 200 may be read by a reader 300, and the reader 300 may include a processor configured to use the embedded link to access the food product information in the database 210 on product information storage 195. When the consumer 180 reads the information tag 200 with a reader 300 and activates the link, the consumer 180 may receive at least some of the food product information from database 210. Some readers 300 may include a display 310 and be configured to display food product information for the consumer 180. Suitable readers 300 may include, but are not limited to, one or more of: (i) a bar code scanner, (ii) a smart phone, (iii), a personal digital assistant, (iv) a tablet computer, and (v) a camera. The reader 300 may follow the link and access the database 210 over a wired or wireless communication system. The link may include may include one or more of: (i) a uniform resource locator, (ii) a hyperlink, and (iii) an anchor link.

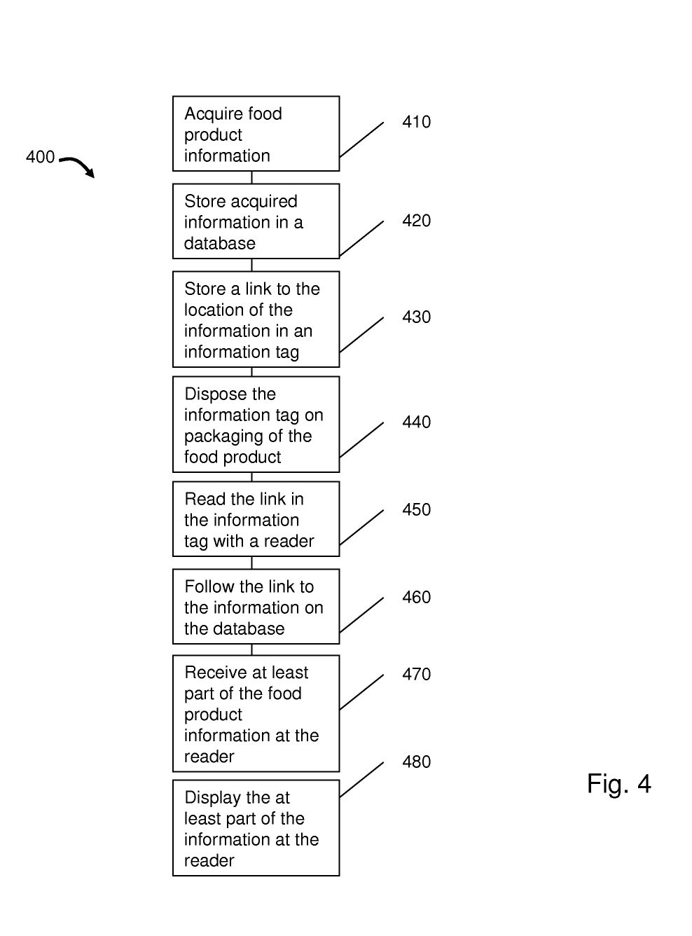

FIG. 4 shows a flow chart of a method 400 according to one embodiment of the pending disclosure. In step 410, the food product information may be acquired. Acquisition may be due to transmission by a data source and/or by data collection by the receiver. In step 420, the acquired food product information may be stored in a database 210 on a suitable information storage medium 195, including, but not limited to, one or more of: (i) a server, (ii) a hard disk, (iii) a solid state memory storage device, and (iv) a cloud resource. In step 430, a link to the memory location of the food product information in the database may be stored in an information tag 200. The link may include any suitable data link or data pointer including, but not limited to, (i) a uniform resource locator, (ii) a hyperlink, and (iii) an anchor link. The information tag 200 may include any form of physical tag configured to store a suitable machine-readable bar code 230, including, but not limited to, one of: (i) a linear bar code and (ii) a two-dimensional bar code. In step 440, the information tag 200 may be disposed on packaging material of the food product. In step 450, the information tag 200 may be read by a suitable reader 300. A suitable reader 300 may include any device configured to read the bar code 230, including, but not limited to, one of: (i) a bar code scanner, (ii) a smart phone, (iii) a personal digital assistant, (iv) a tablet computer, and (v) a camera. In step 460, the reader 300 may follow the link to the location of information on the database 210. The reader 300 may follow the link over any suitable data communication media, wired or wireless, including but not limited to, one of: (i) the Internet, (ii) a cellular data network, (iii) a wireless communication network, and (iv) a data cable. In step 470, the reader 300 may receive at least part of the food product information from the database 210. In step 480, the reader 300 may display the at least part of the food product information.

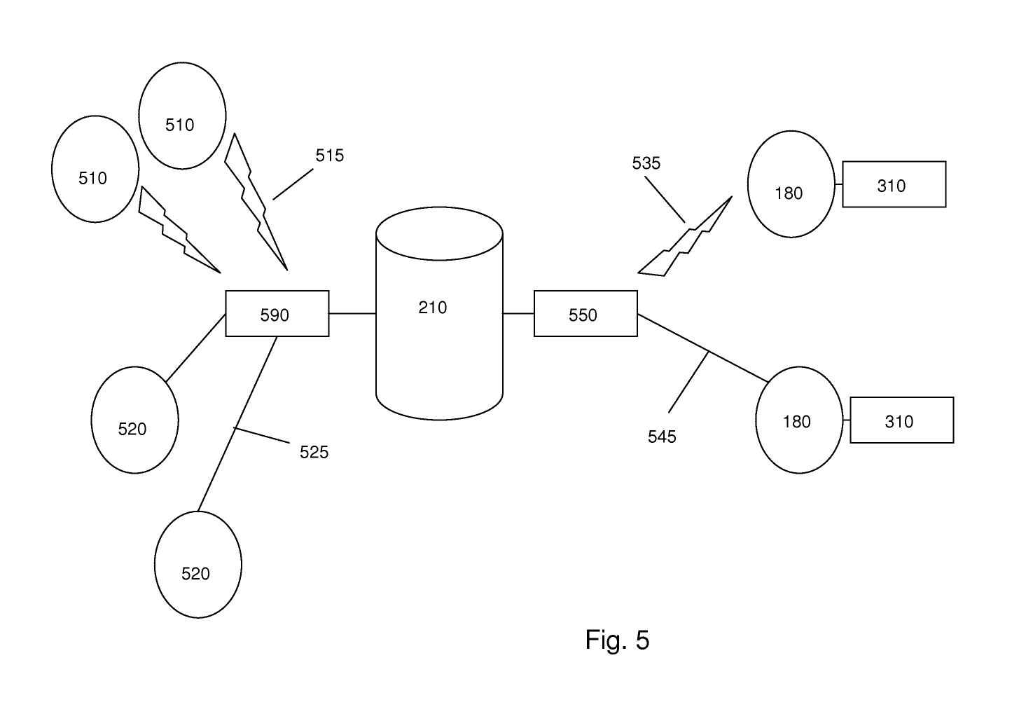

FIG. 5 shows an exemplary diagram of a system 500 for providing product information according to one embodiment of the present disclosure. Data sources 510 and 520 may transmit food product information to an interface 590 configured to receive information and store the information on database 210. Data sources 510 are shown transmitting information wirelessly 515, and data sources 520 are shown transmitting information over wired media 525. Data sources 510 and 520 may continue to populate database 210 even after information tag 200 has been generated, so long as the link embedded in the information tag 200 points to the same location in database 210 that is being populated by new information about the food product. Consumers 180 may communicate with the database 210 using a reader 300 over a wireless network 535 and/or a wired communications medium 545. In some embodiments, an interface 550 may manage data traffic between the communications media 535, 545 and database 210. In some embodiments, a single device may operate as interface 550 and interface 590. Once the link has been read by reader 300, the reader 300 may access the database 210 over either of paths 535 and 545. Food product information residing on the database 210 at the location identified by the link may be transmitted over either of paths 535 and 545 to the reader 300 for use by consumer 180. In some embodiments, the reader 300 may be associated with a display 310 and be configured to display at least some of the food product information for the consumer 180.

ood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

While the foregoing disclosure is directed to the one mode embodiments of the disclosure, various modifications will be apparent to those skilled in the art. It is intended that all variations within the scope of the appended claims be embraced by the foregoing disclosure.

What is claimed is:

1. A method for providing food product information, the method comprising:
generating an information tag configured to be disposed on packaging of a food product, the information tag configured to be read by a reader and comprising a link pointing to a location in a database, wherein the database comprises the food product information at the location and is stored on a non-transitory computer-readable medium.

2. The method of claim 1, further comprising:
acquiring the food product information about the food product from at least one information source; and
storing the food product information in the database.

3. The method of claim 1, further comprising:
storing the link to the location of the food product information on the information tag.

4. The method of claim 1, further comprising:
disposing the information tag on the packaging.

5. The method of claim 4, further comprising:
reading the link in the information tag;
following the link to the food product information on the database; and
retrieving at least part of the food product information.

6. The method of claim 5, further comprising:
displaying the at least part of the information.

7. The method of claim 4, wherein the food product information is retrieved over at least one of: (i) the Internet, (ii) a cellular data network, (iii) a wireless communication network, and (iv) a data cable.

8. The method of claim 1, wherein the reader comprises at least one of: (i) a bar code scanner, (ii) a smart phone, (iii) a personal digital assistant), (vi) a tablet computer, and (v) a camera.

9. The method of claim 1, wherein the food product information comprises at least one of:
(i) a source identity, (ii) source conditions, (iii) a quality rating, (iv) a date of processing, (v) a date of birth, (vi) date of planting, (vii) organic/non-organic status, (viii) genetic information, and (ix) contact information.

10. The method of claim 1, wherein the information tag comprises at least one of: (i) a linear bar code and (ii) a two dimensional bar code.

11. The method of claim 1, wherein the link comprises at least one of: (i) a uniform resource locator, (ii) a hyperlink, and (iii) an anchor link.

12. A system for providing food product information, the system comprising:
a non-transitory computer-readable medium;
a database stored on the non-transitory computer-readable medium;
the food product information stored in the database;
an information tag associated with the food product and configured to be read by a reader; and
a link between the information tag and the food product information in the database.

13. The system of claim 12 further comprising:
the reader configured to read the information tag and to retrieve at least part of the food product information from the database using the link.

14. The system of claim 13, wherein the reader is further configured to display the at least part of the food product information.

15. The system of claim 12, wherein the reader comprises at least one of: (i) a bar code scanner, (ii) a smart phone, (iii) a personal digital assistant), (vi) a tablet computer, and (v) a camera.

16. The system of claim 12, wherein the food product information comprises at least one of:
(i) a source identity, (ii) source conditions, (iii) a quality rating, (iv) a date of processing, (v) a date of birth, (vi) date of planting, (vii) organic/non-organic status, (viii) genetic information, and (ix) contact information.

17. The system of claim 12, wherein the information tag comprises at least one of: (i) a linear bar code and (ii) a two dimensional bar code.

18. The system of claim 12, wherein the link comprises at least one of: (i) a uniform resource locator, (ii) a hyperlink, and (iii) an anchor link.

19. A non-transitory computer-readable medium product, the non-transitory computer-readable medium containing instructions thereon that, when executed by at least one processor, perform a method, the method comprising:
generating an information tag configured to be disposed on packaging of a food product, the information tag configured to be read by a reader and comprising a link pointing to a location in a database, wherein the database comprises the food product information at the location and is stored on a non-transitory computer-readable medium.

20. A non-transitory computer-readable medium product of claim 19, wherein the non-transitory computer-readable medium comprises at least one of: (i) a ROM, (ii) an EPROM, (iii) a hard disk, (iv) a non-volatile memory, (v) a memory card, and (vi) a flash memory,
